(19) United States
(12) Patent Application Publication
(10) Pub. No.: US 2015/0356804 A1
(43) Pub. Date: Dec. 10, 2015

(54) VOTE CERTIFICATION SOFTWARE AND PROCESS

(71) Applicants: Jules T. Mitchel, New York, NY (US); Joyce B. Hays, New York, NY (US)

(72) Inventors: Jules T. Mitchel, New York, NY (US); Joyce B. Hays, New York, NY (US)

(73) Assignee: TARGET HEALTH, INC., New York, NY (US)

(21) Appl. No.: 14/735,262

(22) Filed: Jun. 10, 2015

Related U.S. Application Data
(60) Provisional application No. 62/010,089, filed on Jun. 10, 2014.

(51) Int. Cl. G07C 13/00; G06F 21/60

(52) U.S. Cl. CPC G07C 13/00; G06F 21/60

(57) ABSTRACT

A vote certification system for the collection, capture, processing, storage and tracking of data for votes, including a plurality of data origination devices for collecting vote data in electronic communication with a central data server for capturing the vote data, a vote database server for storing the vote data, and a vote document storage server for archiving the vote data. A method for the collection, capture, processing, storage, and tracking of data for votes. A method for creating a certified digital image copy of a vote document. A method for the collection, capture, certification, processing, storage, and tracking of data for votes.

### BACKGROUND OF THE INVENTION

1. Technical Field

The present invention relates to the field of electronic data collection and processing. More specifically, the present invention relates to methods of certifying and collecting votes.

2. Background Art

In the United States, any citizen over the age of 18 has the right to vote, subject to various state regulations, such as barring convicted felons. Most states require their citizens to register in order to vote in an election.

While some voters send in absentee ballots or mail-in ballots, the majority of voters vote at a specific polling place. Officials at the polling place check that a voter is registered, usually from a printed list of names and addresses, and hands the voter the ballot. There are several types of ballots. Voters can mark a choice on the ballot with a pen and the darkened marks are read by an optical mark recognition scanner when the voter is finished. Ballots can be digital and used with a direct-recording electronic voting machine with button or touchscreen navigation, and voting data is recorded in the memory of the machine as well as printed out.

There are several security issues that exist with current voting methods that can result in voter fraud. Without reliable and updated voter registration lists, people can possibly vote more than once, or deceased individuals who have not been removed from the lists can end up voting because someone votes in their place. Hackers or other individuals can tamper with any type of electronic voting machine, either to change votes or to violate secrecy of ballots.

There remains a need for a method of capturing and certifying a vote that has taken place as well as prevent voter fraud.

### SUMMARY OF THE INVENTION

The present invention provides for a vote certification system for the collection, capture, processing, storage and tracking of data for votes, including a plurality of data origination devices for collecting vote data in electronic communication with a central data server for capturing the vote data, a vote database server for storing the vote data, and a vote document storage server for archiving the vote data.

The present invention provides for a method for the collection, capture, processing, storage, and tracking of data for votes by electronically collecting vote data at a voting site, instantly preserving all of the vote data as an electronic vote document on computer readable media, archiving the vote data in a trusted data server maintained by a third party, transmitting an acknowledgement by the trusted data server upon successful archiving of the vote data, and transmitting the vote data to a vote database server only after successful archiving of the vote data.

The present invention also provides a method for creating a certified digital image copy of a vote document by uploading a modifiable digitized image of a paper vote document into a document memory, displaying the modifiable digital image copy on a certification interface, comparing the modifiable digital image copy to the paper vote document, determining that the modifiable image copy is an exact copy of the paper vote document, certifying the modifiable digital image copy to be an exact copy of the paper vote document by permanent attachment of an electronic signature to the modifiable digital image copy by means of a copy processor, and rendering the certified digital image copy unmodifiable by means of the copy processor.

The present invention also provides for a method for the collection, capture, certification, processing, storage and tracking of data for votes by collecting vote data at a voting site, generating a digital image copy of a paper vote document, certifying the digital image copy of the paper vote document as an exact copy of the paper vote document, notifying an individual of the creation of the certified digital image copy, transmitting the certified digital image copy to the central data server as an electronic vote document, setting a gating module to transmit the electronic vote document from the central data server to a vote document storage server, archiving the electronic vote document at the vote document storage server, and setting the gating module to transmit the electronic vote document to a vote database server only after the electronic vote document has been archived at the vote document storage server.

### DESCRIPTION OF THE DRAWINGS

Other advantages of the present invention are readily appreciated as the same becomes better understood by reference to the following detailed description when considered in connection with the accompanying drawings wherein:

FIG. 1 represents a conceptual overview diagram of the architecture of the vote certification system of the present invention, with solid arrowheads indicating the flow of information among components of the system;

FIG. 2 represents a flow chart of an exemplary method for enforcing the archiving of electronic vote documents in the present invention;

FIG. 3 represents a conceptual diagram of a certification module according to the present invention with solid arrowheads indicating the flow of information among components of the system; and

FIG. 4 represents a flow chart of an exemplary method for creating a certified electronic copy of a paper vote document, with optional steps depicted with dotted outlines and arrows.

### DETAILED DESCRIPTION OF THE INVENTION

The present invention is generally directed to a system and method of providing a vote certification system for the collection, capture, processing, storage and tracking of data for votes, including a plurality of data origination devices for collecting vote data in electronic communication with a central data server for capturing the vote data, a vote database server for storing the vote data, and a vote document storage server for archiving the vote data.

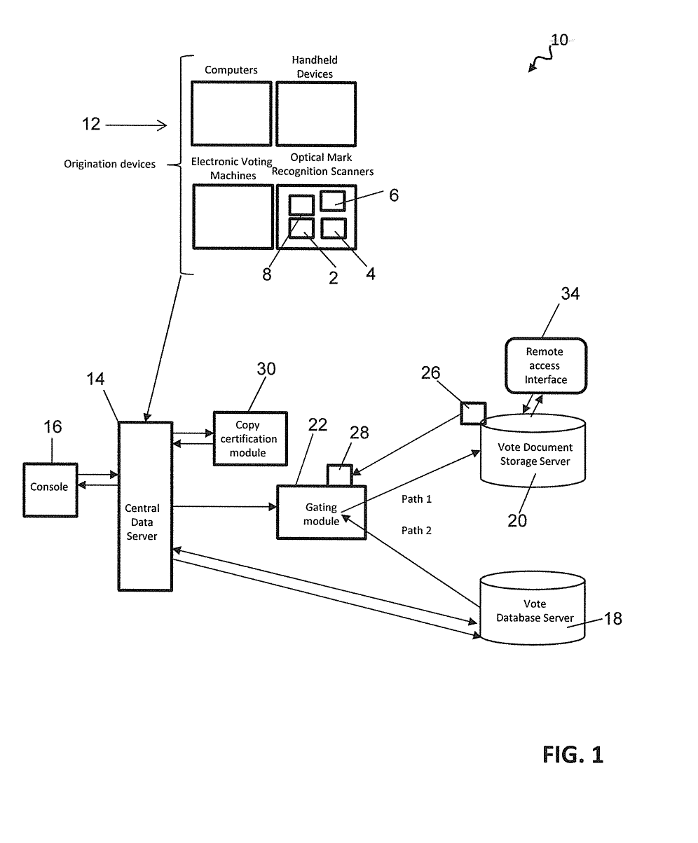

A vote certification system according to the present invention is generally indicated at 10. FIG. 1 represents a diagram of the system's basic architecture and functionality. The vote certification system includes at least one data origination device 12 for the collection of vote data by a data originator at one or more voting sites.

A “data originator”, as used herein, is defined as a person or automated device authorized to enter data into voting ballots. Preferably, the data originator is a registered voter or an authorized voting assistant acting on behalf of an impaired voter.

The data origination devices 12 include, but are not limited to, electronic voting machines (i.e. machines on which voters can vote through buttons or a touchscreen completely electronically), optical mark recognition scanners (i.e. machines that accept a paper ballot and scan and read the marked votes thereon), any other types of scanners that can read paper ballots, computers of the desktop, work station, laptop, and tablet types, smartphones, digital assistants, and other hand-held electronic devices. Paper ballots can also be uploaded to the data origination device 12 through a camera on the device that allows a data originator to take a picture of the paper ballot. The present invention allows a data originator to vote on their own personal electronic device, especially when their vote is certified, as further described below.

Preferably, the data origination devices 12 include at least a processor 2 for collecting, analyzing and digitizing data, a communications interface 4 to communicate with a central data server 14, and memory 6 sufficient to store data until transmission to the central data server 14. Users such as data originators preferably interact with the vote certification system 10 by means of a user interface (not shown) deployed via a series of web pages, but the system 10 can function using a proprietary software program as well. Data entry can be manual or electronic, such as inputting votes on an electronic voting machine, or paper vote documents can be scanned.

The data origination devices 12 can include a data originator authentication mechanism 8 that correlates a data originator with a registered voter record and prohibits the data originator from creating a vote document (i.e. voting) until a correlation has been made and prohibits multiple vote documents from being created by a single data originator for a particular election. The registered voter record can be maintained by a third party that does not have an interest in the election. The data originator authentication mechanism 8 can require and accept input of a name, address, date of birth, identification number (such as driver's license, state identification number, or social security number), fingerprint, or any other identifying information of the data originator that can be correlated with the registered voter record. The data originator authentication mechanism 8 can be in electronic communication with death records, and can delete names of deceased individuals from the registered voter record. Therefore, the data originator authentication mechanism 8 eliminates voter fraud caused by multiple votes or by individuals voting who are actually deceased and certifies that only living individuals vote.

“Vote data” as used herein, can include, but is not limited to, voter name, address, party, voting choices (of candidates, proposals, etc.), date, time, and polling location.

Data collected by the data origination devices 12 are transmitted to the central data server 14, which captures vote data as an electronic vote document. Preferably the data are transmitted via the Internet, but the data can alternatively be relayed by any suitable networking protocol via wired or wireless local, metropolitan, and wide area networks. The operation of the central data server 14 is preferably supervised by an administrator-operated console 16. The central data server is also accessible to authorized users through at least one user interface (not shown). The central data server 14 is not necessarily a single physical entity, but can be a virtual server including a plurality of servers distributed at various local and distant sites, the servers being networked together to function as a central data server 14.

In addition to its data capture functionality, the central data server 14 provides at least temporary record storage and runs software to control the formatting, copying, and flow of records through the vote certification system. Administrators of the vote certification system 10 can, by means of the console 16, regulate and track the issuance and storage of passwords, the assignment of permitted roles in vote certification to users, and the authentication of users logging onto the system 10.

The central data server 14 preferably captures incoming vote data as a human-readable electronic vote document, in formats including but not limited to PDF, XML, JPEG, or the data table files of any suitable database known in the art. The captured data elements can include data element identifiers such as the identity of the originator, the date of addition or modification, and the reason for the addition or modification. If the originator is a device or instrument, the central data server 14 captures a data element identifier that identifies the instrument and the authority that validated it for use. Preferably, the central data server 14 also assigns and links identifying document attributes to the electronic source document, such as a serial number and a characteristic such as “new vote document” or “modified vote document”. All of the data element identifiers linked to an electronic vote document constitute an audit trail of data-related events for that document. In the preferred embodiment, these data-related events are collected and recorded in a log maintained preferably in the central data server 14.

The vote certification system 10 also includes a vote database server 18, which stores electronic vote records for access by the public (certain public information about a vote that is permitted to be accessed, such as name, address, party affiliation, and past votes cast) on computer readable media; a vote document storage server 20, to archive electronic vote documents for access by authorized individuals or organizations for a particular election but not by the public (such as an electoral college); and a gating module 22 interconnecting the central data server 14 to both the vote document storage server 20 and the vote database server 18. The vote document storage server 20 and the vote database server 18 need not be individual physical entities but can be virtual servers, each including a plurality of networked servers distributed at various local and distant sites.

The vote document storage server 20 is not under the control of the public or other parties having an interest in outcome of an election. Preferably, the vote document storage server 20 is maintained and controlled by a third party independent of the election, and more preferably a third party disinterested in the outcome of the election (in other words, it is a trusted data server maintained by a third party). The vote document storage server 20 serves as an independent repository of archived electronic vote documents. These documents can be accessed through at least one remote access interface 24 by electoral colleges, any organization authorized to count votes in an election, regulatory agencies, and any other parties authorized to monitor the quality and integrity of the electronic vote documents. Previously, these parties could only ensure this degree of data integrity by reviewing the collected paper vote documents. These parties can view the actual vote that was cast by a voter on a display, and this vote is impossible to change or alter in any way. Once the vote document is sent to the vote document storage server 20, it is secure from any alteration.

Vote documents and other electronic records stored in the vote database server 18 can be accessible to the public. Preferably they are stored in an unlocked form, so that individuals and organizations can extract data for the preparation of summaries, analyses, and reports.

The gating module 22 performs an enforced archiving function, allowing an electronic vote document to be transmitted to the vote database server 18 only after that electronic vote document has first been archived in the vote document storage server 20. This enforced archiving function ensures that a pristine, original version of an electronic vote document is archived securely and out of the control of the parties running the election. This greatly decreases the chances of voter fraud by tampering with votes. Regulators and other auditing parties can compare the archived vote document to the version on the vote database server, and to reports derived from that version, with confidence that the archived vote document truly represents the vote data as originally recorded.

The gating module 22 performs its enforced archiving function by controlling a branch point interconnecting the central data server 14 to the vote document storage server 20 via a first path, and interconnecting the central data server 14 to the vote database server 18 via a second path, as best shown in FIG. 1.

The gating module 22 is settable to allow transmission of electronic vote documents either along the first path or the second path. In its default setting, the gating module 22 opens the first path to allow transmission of a vote document from the central data server 14 to the vote document storage server 20 for secure archiving. The vote document storage server 20 includes an acknowledgment signal generator 26 to transmit an acknowledgment signal after an electronic vote document has been successfully archived. The gating module 22 includes an acknowledgment signal receiver 28 to receive the acknowledgment signal. Preferably, the acknowledgement signal is transmitted via the same network and transmission protocol utilized to transmit documents among the components of the system 10, but the signal can alternatively be transmitted by any means known in the art, including but not limited to Bluetooth, WiFi, and mobile phone protocols (SMS and texting). During all electronic transmissions of the first path, the second path is maintained closed.

Upon receipt of an acknowledgment signal, the gating module 22 resets to open the second path to allow the electronic document to be transmitted from the central data server 14 to the vote database server 18. Preferably, the gating module 22 is also configured to close the first path upon receipt of an acknowledgment signal, so that the first and second paths are never simultaneously open. This is a further safeguard of the integrity of the vote document storage server 20.

An acknowledgement notice can also be transmitted to a voter (data originator) to let them know that their vote has been successfully archived by Bluetooth, WiFi, or mobile phone protocols (SMS and texting) and that the vote is being sent to any organizations interested in the vote or to the vote database server 18. Once archiving has been performed, a voter (data originator) can be locked out from the data origination device 12 to prevent multiple votes from occurring from the same voter.

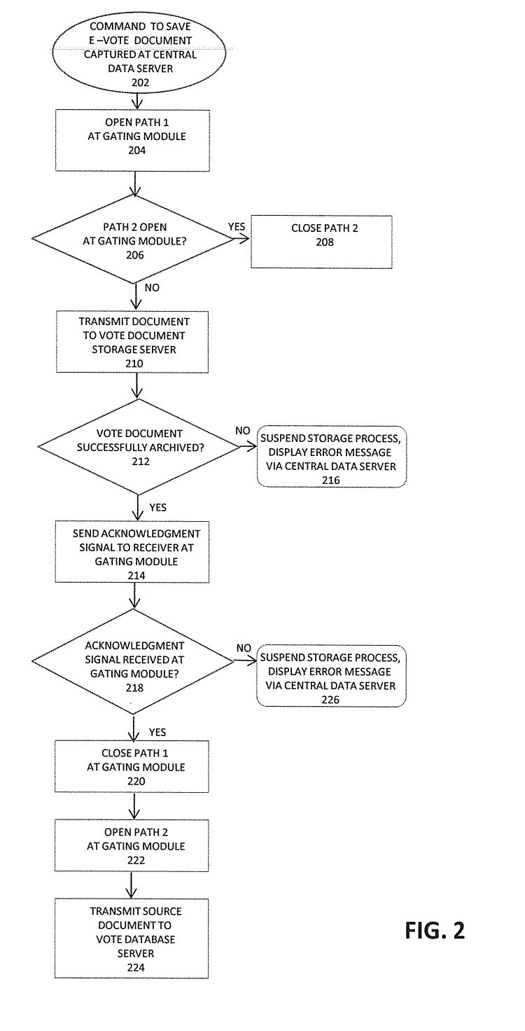

A flow chart depicting an exemplary method for enforcing the archiving of electronic vote documents before admitting them to the vote database server 18 is diagrammed in FIG. 2. An authorized user at a user interface commands the saving of an electronic vote document which has been captured at the central data server, at 202. In response, the gating module 22 opens path 1 connecting the central data server 14 to the vote document storage server 20, at 204. If path 2 connecting the central data server 14 to the vote database server 18 is open, at 206, the gating module closes path 2, at 208. The electronic vote document is transmitted to the vote document storage server 20, at 210. If the electronic vote document is successfully archived, at 212, an acknowledgment signal is sent from the acknowledgment signal transmitter 26 at the vote document storage server 20 to the acknowledgment signal receiver 28 at the gating module 22, at 214. If the electronic vote document has not been successfully archived, at 212, no acknowledgment signal is sent, and the storage process is suspended, at 216. Preferably, an error message is also sent to the user, at 216. If an acknowledgment signal is received by the gating module signal receiver 28, at 218, the gating module 22 opens path 2 connecting the central data server 14 to the vote database server 18, at 220, and preferably closes path 1, at 222. The central data server 14 then transmits the vote document to the vote database server 18, at 224. If no acknowledgment signal is received by the gating module signal receiver 28, then the storage process is suspended, and an error message is preferably sent to the user, at 226.

The gating module 22 is preferably situated within the central data server 14, but it can also be situated within the vote document server 20 or can be included in a discrete device operatively interconnecting the central data server 14 to the secure vote document server 20 and the vote database server 18. The gating module 22 can include a mechanical gating switch (not shown) of any type known in the art. Alternatively, the opening and closing of paths 1 and 2 can be controlled by logic circuits within a processor (not shown) situated in the gating module 22.

To facilitate the enforced archiving function of the gating module 22, the operating software of central database server 14 is preferably configured to bar a new or modified electronic vote document from being transmitted by any route other than through the gating module 22. For example, an authorized user can retrieve a vote document from the vote database 18 and transmit it to the central data server 14 in order to add or modify data elements. When the user submits the modified vote document for capture and storage, the central data server 14 recognizes the linked document attribute “vote document” and responds by routing the vote document to the gating module 22, to ensure archiving at the vote document storage server 20 before transmission to the vote database server 18.

Therefore, generally the invention provides for a method for the collection, capture, processing, storage, and tracking of data for votes by electronically collecting vote data at a voting site, instantly preserving all of the vote data as an electronic vote document, archiving the vote data in a trusted data server maintained by a third party, transmitting an acknowledgement upon successful archiving of the vote data, and transmitting the vote data to a vote database server only after successful archiving of the vote data.

More specifically, as described above, vote data is electronically collected at a voting site by the data origination devices 12 and sent to the central data server 14, where it is instantly preserved as an electronic vote document. The electronic vote document is archived in the vote document storage server 20, which is maintained by a third party. The vote document storage server 20 transmits an acknowledgement upon successful archiving of the vote data, and the vote data can then be transmitted to the vote database server 18 via the gating module 18 when archiving has been successful.

The vote certification system 10 can also include a copy certification module 30 to perform the steps required to create an unmodifiable digital image copy of a paper vote document (i.e. a paper ballot), with the unmodifiable digital image copy being permanently attached to an electronic signature certifying that the digital image copy is an exact copy having all of the same attributes and information as the original paper document.

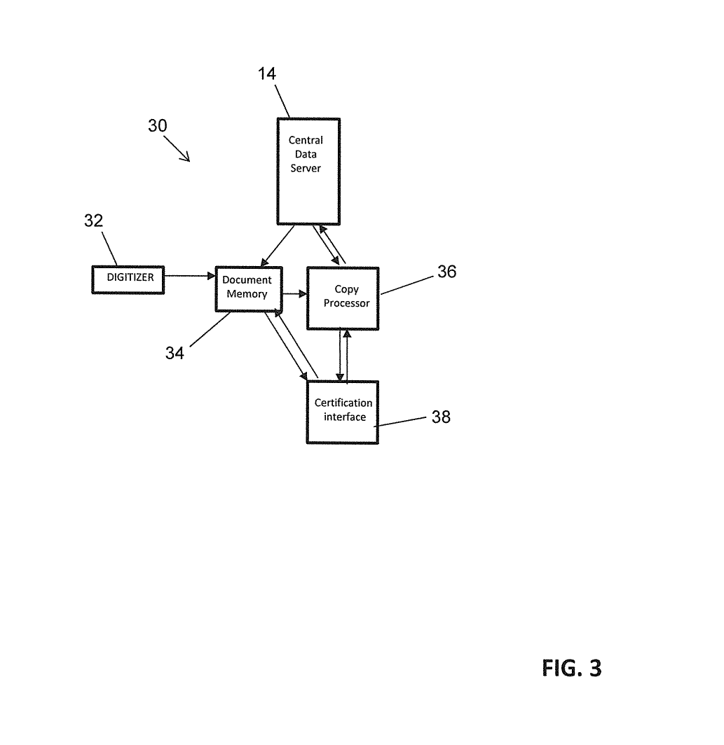

The copy certification module 30, best shown in FIG. 3, includes a document digitizer 32 to generate a modifiable digital image copy of a paper vote document; a document memory 34 operatively connected to the document digitizer 32, to store the digital image copy; a copy processor 36 operatively connected to the document memory 34 and the central data server 14, to attach an electronic signature to the modifiable digital image copy, to certify the modifiable digital image copy, and then render the certified digital image copy unmodifiable; and a certification interface 38 operatively connected to the document memory 34, to the copy processor 36, and to the central data server 14. The certification interface 38 displays the digital image copy of an electronic vote document for comparison with the original paper vote document. The certification interface 38 also transmits user commands to the copy processor 36 to permanently attach a digital signature to certify digital image copy. The communicative connection between the copy processor 36 and the central data server 14 permits the transmission of the finished certified digital image copy to the central data server 14, from which it is routed to the gating module 22 for archiving in the source data storage server 20 and transmission to the clinical trial database server 18.

The present invention also provides for a method for creating a certified digital image copy of a paper vote document including the steps of uploading a modifiable digitized image of a paper vote document into a document memory, displaying the modifiable digital image copy on a certification interface, comparing the modifiable digital image copy to the paper vote document, determining that the modifiable image copy is an exact copy of the paper vote document, certifying the modifiable digital image copy to be an exact copy of the paper vote document by permanent attachment of an electronic signature to the modifiable digital image copy by means of a copy processor, and rendering the certified digital image copy unmodifiable by means of the copy processor.

The certification interface also runs software operable to create and populate a human-readable certification form including a history of data-related events associated with a vote document, insert a user's digital signature upon the user's command, and permanently incorporate the human readable certification form into a digital image copy before the copy is rendered unmodifiable.

The digitizer 32 can include a scanner or digital camera (not shown) or any digitization device known in the art to convert a paper document into a digital image for upload is a separate device independent of the vote certification system 10, and the uploading of a digital image into the document memory 34 is performed by any networking means known in the art, or by means of a transportable physical storage medium.

The document memory 34 includes at least one memory device of any suitable type, operatively connected to the digitizer 32 and the copy processor 36. The steps of digitizing a paper vote document and creating a certified digital image copy need not be performed concurrently. The communicative connection between the document memory 34 and the central data server 14 permits a digital image copy to be stored in the central data server 14 and later retrieved into certification module 30 for the creation of a certified digital image copy.

The copy processor 36 according to the present invention includes any electronic processor with the capability of running any software known in the art to render a digital image copy unmodifiable. Preferably, the copy processor 36 runs software that can create and display an image in a modifiable format and then save it in a locked, “read only” format. For example, the processor can run Adobe Acrobat® software, paste a JPEG or TIF image of a vote document into a PDF file, and then save the file as a locked, read-only PDF file.

The copy processor 36 can also include image editing software enabling a user to adjust, or command the automatic adjustment of, image quality properties of a digital image copy, before the copy is rendered unmodifiable. Image quality properties include such properties as image size, brightness, and contrast, and cropping. The image editing software is preferably incapable of editing or altering text, or performing operations that could alter the informational content of a digitized image, such as erasing, dodging, or airbrushing. The image editing software also preferably includes the capability of attaching a human-readable certification form to the digital image copy prior to rendering the digital image copy unmodifiable.

A certification interface 38 according to the present invention includes any computer or other processor configured to display a digital image copy of a document on a suitable monitor or other display. The certification interface 38 also includes a graphical user interface (GUI) (not shown) to enable a user to issue commands to the copy processor 36 to permanently affix the user's electronic signature to the digital image copy, render the digital image copy unmodifiable, and transmit the certified digital image copy to the central data server 14 for archiving at the vote document storage server 20. The certification interface 38 is not necessarily a dedicated device, but can instead represent one aspect of an existing computer or other device such as, but not limited to, an electronic voting machine, optical mark recognition scanners, desktop, laptop, or tablet computing device, or a smart phone or other hand held device.

The certification interface 38 also runs software for creating the human-readable certification form and for commanding the copy processor 36 to incorporate the form into the digital image copy. The certification interface 38 also populates the certification form with required information such as the unique identifiers of the original document and of the copy, the date and time of certification, and a signed statement that the signer has certified the electronic image copy as an exact copy having all of the same attributes and information as the original document. The certification interface 38 can additionally populate the certification form with any information required for the maintenance of an audit trail, including but not limited to the identity of the originator of data in the document, the date and time of origination and of copying, and the date and time of certification. The certification interface 38 can draw this information automatically from the central data server 14 or other storage device. Alternatively, the information can be entered manually via the GUI of the certification interface 38, or by a combination of automatic transfer and manual entry. The advantage of the human readable certification form is that it makes the audit trail and certification immediately visible to auditors when a digital image copy of a vote document is displayed at a remote access interface. A printed version of the certified digital document can also be generated by the user.

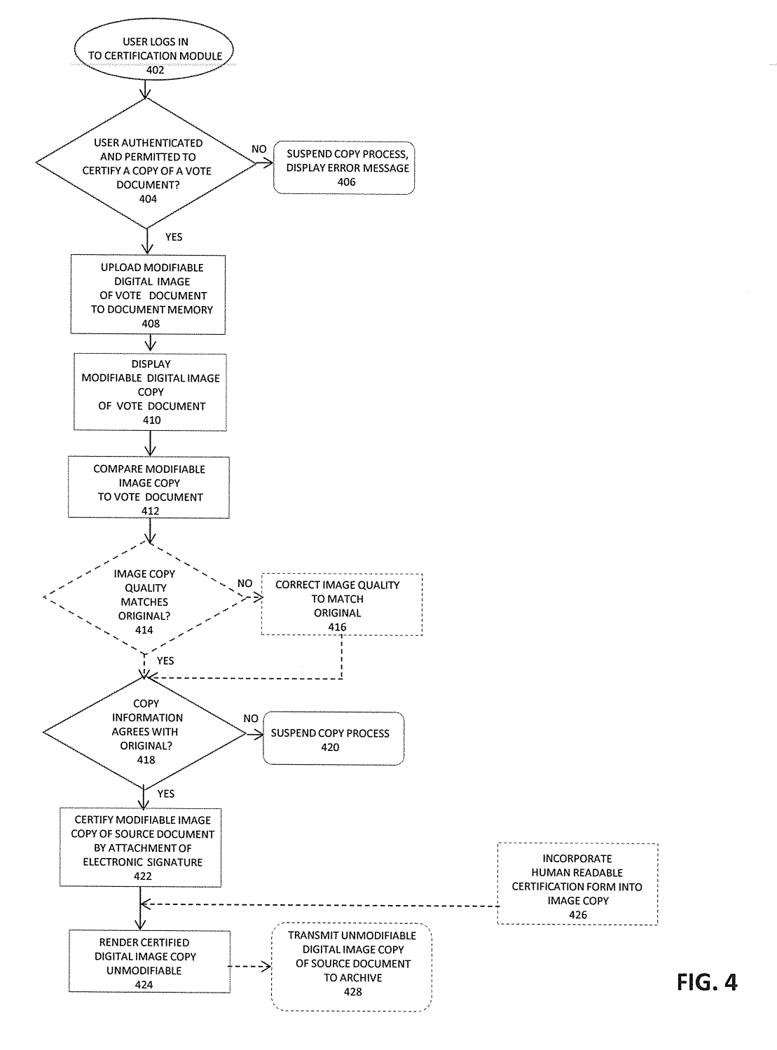

A flow chart depicting an exemplary method of operation of the certification module 30 is diagrammed in FIG. 4. A user initiates the certified copying process by logging into the certification interface 38 at 402. The log-in process includes the submission of electronic credentials showing the user to be an authorized user of the system, and to have permission to create and certify digital image copies of paper vote documents. If the user's authentication and/or permission is found to be deficient, at 404, the certification interface 38 displays an error message on the GUI and aborts the certification process, at 406. If the user's authentication and authority are sufficient, at 404, the user uploads a modifiable digital image copy of the original document into the document memory 34 of the copy certification module 30, at 408. The copy processor 36 accesses the modifiable digital image copy and displays it on the GUI of the certification interface 38, at 410. The user compares the modifiable digital image copy to the paper vote document, at 412. The user makes comparisons with respect to both informational content and, optionally, of image quality.

If the user determines the image quality of the digital image copy to be discrepant from that of the original document, at 414, the user next uses the image editing software of the copy processor 36 to adjust the image until its image quality matches that of the original paper document, at 416. If the user determines that the informational content of the digital image copy is discrepant from that of the original document, to the point that the user cannot attest that it is an exact copy of the original, at 418, then the user aborts the copy certification process, at 420. If the user can attest that the digital image copy is an exact copy of the original document, at 418, the user next commands the certification interface 38 to permanently attach a digital signature certifying that the electronic image copy is an exact copy of the original source document, at 422. The user then commands the copy processor 36, to render the digital image copy unmodifiable, at 424, as previously described.

A user also has the option of incorporating a human-readable electronic certification form into the digital image copy before the copy is rendered unmodifiable, at 426. Preferably, the certification form is incorporated by superimposing it onto the digital image copy, for example by commanding the copy processor 36 to paste the form onto a blank portion of the copied digital image by means of the image editing software. The digital image copy can include a blank frame to receive the certification form. Alternatively, the digital image copy and certification form can be included on separate pages of a single document, which is then rendered unmodifiable. For example, the digital image copy and certification form can be inserted by the copy processor 36 onto successive pages of a PDF or Microsoft Word document, with the document immediately saved in a permanently locked “read only” format.

Once a certified unmodifiable digital image copy of a vote document has been created by the certification module 30, it is preferably transmitted to the previously described gating module 22, via the central data server 14, for archiving. Also, once the certified unmodifiable digital image copy of a vote document has been created, a notice of the creation (such as a message, alert, email, etc.) can be sent to an interested individual, such as those tabulating the results of an election, or the voter themselves to provide confirmation of certification.

The present invention provides a method for creating a certified digital image copy of a vote document by uploading a modifiable digitized image of a paper source document into a document memory, displaying the modifiable digital image copy on a certification interface, comparing the modifiable digital image copy to the paper source document, determining that the modifiable image copy is an exact copy of the paper source document, certifying the modifiable digital image copy to be an exact copy of the paper source document by permanent attachment of an electronic signature to the modifiable digital image copy by means of a copy processor, and rendering the certified digital image copy unmodifiable by means of the copy processor.

The present invention also provides for a method for the collection, capture, processing, storage and tracking of data for votes by collecting vote data at a voting site, generating a digital image copy of a paper vote document, certifying the digital image copy of the paper vote document as an exact copy of the paper vote document, notifying an individual of the creation of the certified digital image copy, transmitting the certified digital image copy to the central data server as an electronic vote document, setting a gating module to transmit the electronic vote document from the central data server to a vote document storage server, archiving the electronic vote document at the vote document storage server, and setting the gating module to transmit the electronic vote document to a vote database server only after the electronic vote document has been archived at the vote document storage server. Each of these steps have been described above.

All data and document transmissions occurring within the system of the present invention are encrypted to ensure the security of the data. The system 10 of the present invention also incorporates the use of unique user accounts and passwords for each system user. A system administrator, via the console 30, assigns each system user a user ID and password, which are used when logging onto the system. Each user is assigned specific permissions by the administrator. The use of unique user ID”s is also critical to the operation of the present invention's audit trail functionality, as described below.

Throughout the operation of the system, all data-related events are logged and stored in an audit trail. The present invention maintains a comprehensive audit trail log and history of all data-related activity and communication occurring within the system, specifically events related to data capture and access. Preferably, the audit trail information is collected directly from the data element attributes of electronic vote documents at the moment they are captured at the central data server 14. This ensures the integrity of the collected data, by keeping a comprehensive record of all data-related events. At any point, the audit trail can be printed out on paper with a printing mechanism by a user if needed for review. It should also be understood that any other data or electronic documents generated in the present invention can be printed out as well.

The present invention has the technical effect of capturing and producing certified documents in a digital image, as well as generating printed materials and generating notices for relevant individuals. The present invention also has the technical effect of improving the integrity of electronic records due to the audit trail.

The system and method of the present invention provide several advantages over the current system of voting, including assuring the integrity of votes to prevent multiple votes from a single person, from deceased individuals, or from those individuals not registered and identity confirmed. The present invention provides transparency of voting because the original vote of an individual is captured, preserved, and stored in the vote document storage server 20 where it cannot be altered and analysis of the votes is controlled by a neutral third party. Furthermore, the vote database server provides an easy place for the public to access information about votes.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A vote certification system for the collection, capture, processing, storage and tracking of data for votes, comprising a plurality of data origination devices for collecting vote data in electronic communication with a central data server for capturing said vote data, a vote database server for storing said vote data, and a vote document storage server for archiving said vote data.

2. The vote certification system of claim 1, wherein said data origination devices are chosen from the group consisting of electronic voting machines, optical mark recognition scanners, scanners that can read paper ballots, desktop computers, work station computers, laptop computers, tablet computers, smartphones, digital assistants, and hand-held electronic devices.

3. The vote certification system of claim 1, wherein said data origination devices further include camera means for taking a picture of a paper ballot.

4. The vote certification system of claim 1, wherein said data origination devices further include a data originator authentication mechanism that correlates a data originator with a registered voter record and prohibits said data originator from creating a vote document until a correlation has been made and prohibits multiple vote documents from being created by a single data originator for an election.

5. The vote certification system of claim 4, wherein said data originator authentication mechanism accepts an input chosen from the group consisting of name, address, date of birth, identification number, and fingerprint.

6. The vote certification system of claim 4, wherein said data originator authentication mechanism is in electronic communication with death records.

7. The vote certification system of claim 1, wherein said central data server captures said vote data as an electronic vote document stored on computer readable media.

8. The vote certification system of claim 7, wherein said vote data includes an identity of an originator, a date of addition or modification, and a reason for the addition or modification.

9. The vote certification system of claim 1, wherein said central data server further includes an audit log of data-related events.

10. The vote certification system of claim 1, wherein said vote database server includes stored electronic vote records on computer readable media and is accessible by the public.

11. The vote certification system of claim 1, wherein said vote document storage server includes archived electronic vote documents accessible by authorized individuals or organizations.

12. The vote certification system of claim 1, further including a gating module that interconnects said central data server to said vote document storage server and said vote database server, and allows an electronic vote document to be transmitted to said vote database server only after said electronic vote document is first archived in said vote document storage server.

13. The vote certification system of claim 12, wherein said vote document storage server includes an acknowledgement signal generator that transmits an acknowledgement signal after said electronic vote document is successfully archived, and wherein said gating module includes an acknowledgement signal receiver for receiving said acknowledgement signal.

14. The vote certification system of claim 1, further including a certification module for creating a certified digital image copy of an original vote document.

15. The vote certification system of claim 14, wherein said certification module includes a document digitizer, a document memory operatively connected to said document digitizer, a copy processor operatively connected to said document memory and said central data server, and a certification interface operatively connected to said document memory, said copy processor, and said central data server.

16. A method for the collection, capture, processing, storage, and tracking of data for votes, including the steps of:
electronically collecting vote data at a voting site;
instantly preserving all of the vote data as an electronic vote document on computer readable media;
archiving the vote data in a trusted data server maintained by a third party;
transmitting an acknowledgement by the trusted data server upon successful archiving of the vote data; and
transmitting the vote data to a vote database server only after successful archiving of the vote data.

17. The method of claim 16, wherein said electronically collecting step is accomplished with data origination devices chosen from the group consisting of electronic voting machines, optical mark recognition scanners, scanners that can read paper ballots, desktop computers, work station computers, laptop computers, tablet computers, smartphones, digital assistants, and hand-held electronic devices.

18. The method of claim 16, wherein said electronically collecting step further includes authenticating and correlating a data originator with a registered voter record and prohibiting the data originator from creating the electronic vote document until a correlation has been made and prohibiting multiple electronic vote documents from being created by a single data originator for an election.

19. The method of claim 16, wherein said electronically collecting step further includes the step of electronically communicating with death records and deleting names of deceased individuals from a registered voter record.

20. The method of claim 16, wherein said instantly preserving step is further defined as sending the vote data to a central data server.

21. The method of claim 16, wherein the vote data includes an identity of an originator, a date of addition or modification, and a reason for the addition or modification.

22. The method of claim 16, wherein said archiving step is further defined as transmitting electronic vote data along a first path of a gating module from the central data server to the trusted data server, while maintaining a second path to the vote database server as closed until said transmitting an acknowledgement step is performed.

23. The method of claim 22, further including the step of closing the first path of the gating module and opening the second path to perform said transmitting the vote data to a vote database server step.

24. The method of claim 16, further including the step of transmitting an acknowledgement to a data originator that their vote has been archived.

25. The method of claim 16, further including the step of collecting and recording data-related events in an audit trail.

26. The method of claim 16, further including the step of providing access to electronic vote records to the public in the vote database server.

27. The method of claim 16, further including the step of providing access to electronic vote records to authorized individuals and organizations in the trusted data server.

28. A method for creating a certified digital image copy of a vote document, including the steps of:
uploading a modifiable digitized image of a paper vote document into a document memory;
displaying the modifiable digital image copy on a certification interface;
comparing the modifiable digital image copy to the paper vote document;
determining that the modifiable image copy is an exact copy of the paper vote document;
certifying the modifiable digital image copy to be an exact copy of the paper vote document by permanent attachment of an electronic signature to the modifiable digital image copy by means of a copy processor; and
rendering the certified digital image copy unmodifiable by means of the copy processor.

29. A method for the collection, capture, certification, processing, storage, and tracking of data for votes, including the steps of:
collecting vote data at a voting site;
generating a digital image copy of a paper vote document;
certifying the digital image copy of the paper vote document as an exact copy of the paper vote document;
notifying an individual of the creation of the certified digital image copy;
transmitting the certified digital image copy to the central data server as an electronic vote document;
setting a gating module to transmit the electronic vote document from the central data server to a vote document storage server;
archiving the electronic vote document at the vote document storage server; and
setting the gating module to transmit the electronic vote document to a vote database server only after the electronic vote document has been archived at the vote document storage server.
